(19) United States
(12) Patent Application Publication
(10) Pub. No.: US 2009/0006227 A1
(43) Pub. Date: Jan. 1, 2009

(54) SYSTEM AND METHOD FOR GENERATING CONSOLIDATION INDICATORS

(76) Inventors: Michael P. Chen-Young, Bethesda, MD (US); Lindsay Nicole Clark, Alexandria, VA (US); Dawn R. Damico, Potomac, MD (US); Jeff Lee Pizzino, Ellicott City, MD (US)

Correspondence Address: FANN-MKE C/O;FOLEY & LARDNER LLP, 777 EAST WISCONSIN AVENUE, MILWAUKEE, WI, 53202-5306, US

(21) Appl. No.: 12/139,180

(22) Filed: Jun. 13, 2008

Related U.S. Application Data
(60) Provisional application No. 60/944,049, filed on Jun. 14, 2007.

(51) Int. Cl. G06Q 10/00; G06Q 50/00

(52) U.S. Cl. 705/30

(57) ABSTRACT

A investment portfolio accounting system and method are provided. The system determines the percentage ownership in a number of investment securities. The system flags securities according to predetermined accounting and business rules. Consolidating or derecognizing the security with others interests is also determined by the system in accordance with predetermined rules. In one example, the accounting system flags (or communicates) a determination to consolidate according to percentage ownership. System reports generated by the accounting system are chronicled in a reporting database for downstream accounting systems.

### CROSS REFERENCE TO RELATED APPLICATIONS

This application claims the benefit of U.S. Prov. Ser. No. 60/944,049, filed Jun. 14, 2007, entitled “System and Method for Generating Consolidation Indicators,” hereby incorporated by reference in its entirety.

### BACKGROUND

Financial institutions and other companies frequently issue, trade, and otherwise buy and sell financial instruments. Various types of financial instruments exist that seek to satisfy different needs of investors that might purchase the instruments. For example, in the mortgage finance industry, such financial instruments include mortgage backed securities (MBSs), real estate mortgage investment conduits (REMICs), grantor trusts, stripped MBSs, whole loan REMICs, private label REMICs, MBS backed by all or portions of MBS that have been consolidated into a larger pool (MEGAs), and so on. These financial instruments may be backed directly or indirectly by interests in mortgage loans that have been sold by lenders into the secondary mortgage market, either alone or as part of a pool of loans. Upon sale of such loans, lenders can turn around and make new loans using proceeds from the sale. In effect, this arrangement facilitates the flow of capital from the global capital markets to the mortgage industry to fund home ownership. The increased availability of capital reduces interest rates as compared to the interest rates that would otherwise be available, and therefore makes home ownership more affordable for an increased number of individuals.

Often, ownership of such financial instruments is divided over multiple investors (e.g., companies that invest in such instruments). For example, when a company issues a security, it may sell fractional interests in the security to a number of different investors, as well as retain the remaining ownership interest for its own portfolio. Also, for some securities, different tranches may be created that have different risk/return profiles.

Issuing financial instruments often involves the creation of entities such as variable interest entities, qualified special purpose entities, bankruptcy-remote entities, trusts, and so on. (Herein, such entities are referred to generically as “investment entities.”) For example, in creating a mortgage-backed security, a bankruptcy-remote trust is established for the purpose of holding the mortgages that back the security.

Various accounting standards govern accounting for investment instruments and investment entities. For example, FIN 46 (FASB Interpretation Number 46, revised December 2003), entitled “Consolidation of Variables Interest Entities” is the accounting rule that addresses the consolidation of variable interest entities (VIEs) and trusts (herein, “FIN 46 investment entities” or, more simply, “FIN 46 entities”). FIN 46 is an interpretation of Accounting Research Bulletin (ARB) No. 51, “Consolidated Financial Statements,” and provides guidance concerning whether variable interest entities must be consolidated onto a company's balance sheet. Variable interest entities, formerly known as special purpose entities (SPEs), are characterized as such based on the inadequacy of at-risk capital and the lack of control exercised by the equity owners. The investment entities discussed above are often variable interest entities. Thus, companies that have ownership interests in such entities apply FIN 46 to determine whether such entities need to be consolidated onto the company's balance sheet.

Under FIN 46, companies that issue securities need to evaluate the securities for percentage ownership to determine proper accounting treatment. Securities may need to be consolidated, deconsolidated, or accounted for as secured borrowings when different ownership percentage thresholds are reached.

In some instances, it may be desirable to perform FIN 46 accounting on a highly granular basis. For example, it may be desirable to perform FIN 46 accounting on a daily basis. This may be desirable, for example, where the day-to-day variations in the percentage ownership and other parameters are sufficient to potentially cause differing daily accounting results under FIN 46. Additionally, it may be desirable to perform more detailed analysis in connection with certain types of structured transactions securities (e.g., REMICs, MEGAs, and so on). For example, for such securities, a “look-through” may be performed to the underlying collateral. In other words, the security is replaced by its underlying collateral pieces for percentage in inventory analysis. The look-through may be iteratively performed on a level-by-level format. That is, if an underlying level of collateral contains another structured transaction security (e.g., another REMIC, MEGA, and so on), this level of look-through is stored, and another look-through is performed on the next underlying level security.

Application of accounting standards often requires qualitative analysis including the exercise of professional judgment. However, such qualitative analysis is often not readily susceptible to being reduced to computer-implemented rules.

An ongoing need exists for improved systems and tools that facilitate appropriate consolidation and de-consolidation of investment entities. However, it should be understood that the techniques described and claimed herein may also be applied to meet other needs instead of or in addition to the above needs.

### SUMMARY

In one embodiment, the invention relates to a computer-implemented data processing system comprising a consolidation engine and an accounting engine. The consolidation engine is configured to perform consolidation testing to assess whether investment entities should be consolidated onto a balance sheet of a reporting entity in accordance with predetermined accounting standards. The investment entities are associated with fungible investment instruments. The consolidation engine is configured to receive accounting treatment indicators which are at least partially manually generated and which reflect qualitative accounting assessments. The consolidation engine is configured to generate consolidation indicators that reflect results of the consolidation testing assessment. The accounting engine is configured to consolidate or deconsolidate the investment entities from the balance sheet of the reporting entity based on the consolidation indicators.

In another embodiment, a computer-implemented data processing system comprises a consolidation engine, a look-through engine, and an accounting engine. The consolidation engine is configured to perform consolidation testing to assess whether investment entities should be consolidated onto a balance sheet of a reporting entity in accordance with predetermined accounting standards. The investment entities are associated with fungible investment instruments. The consolidation engine is configured to generate consolidation indicators that reflect results of the assessment. The look-through engine is coupled to the consolidation engine and is configured to replace tranches of an investment instrument by collateral that backs each tranche and transfer the owned unpaid principal balance of the tranches to the underlying collateral. The look-through engine is configured to cooperate with the consolidation engine to perform additional ownership tests on each of the underlying collateral pieces to determine if additional consolidation is to be performed on the underlying collateral. The accounting engine is to receive the consolidation indicators and to consolidate or deconsolidate the investment entities from the balance sheet of the reporting entity based on the consolidation indicators.

### BRIEF DESCRIPTION OF THE DRAWINGS

The exemplary embodiments will hereafter be described with reference to the accompanying drawings, wherein like numerals denote like elements.

FIG. 1 is an overview of a data processing system that is configured to generate consolidation indicators in accordance with an exemplary embodiment.

FIG. 2 is a flowchart of a process for the generation of consolidation indicators in accordance with an exemplary embodiment.

FIG. 3 is a data flow diagram showing the generation of consolidation indicators in accordance with an exemplary embodiment.

FIGS. 4-11 are flowcharts showing the operation of the consolidation system of FIG. 1 in accordance with an exemplary embodiment.

### DETAILED DESCRIPTION

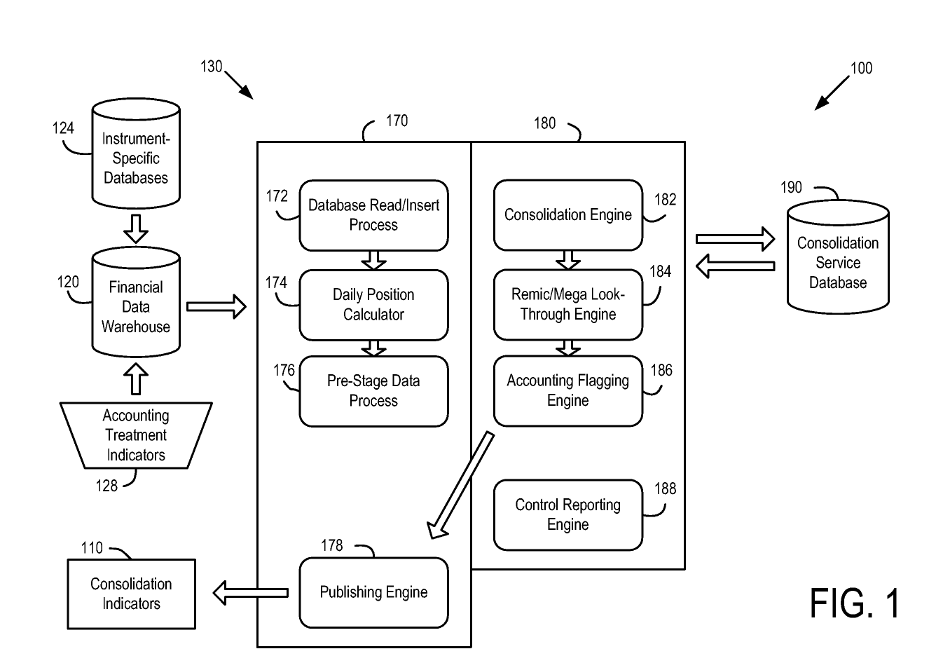

Referring now to FIG. 1, an overview of a computer-implemented data processing system 100 for generating consolidation indicators 110 according to one embodiment is shown. The consolidation indicators 110 may be used to provide downstream accounting systems with ownership and consolidation status information for instruments in a portfolio of investments. Herein, for purposes of providing an example, the data processing system 100 is described in the context of a reporting entity. The reporting entity may be a company that operates the data processing system 100, and uses the data processing system 100 to generate filings for a regulatory body such as the Securities and Exchange Commission. The data processing system 100 may be used to facilitate accounting in compliance with FIN 46 and/or other accounting standards.

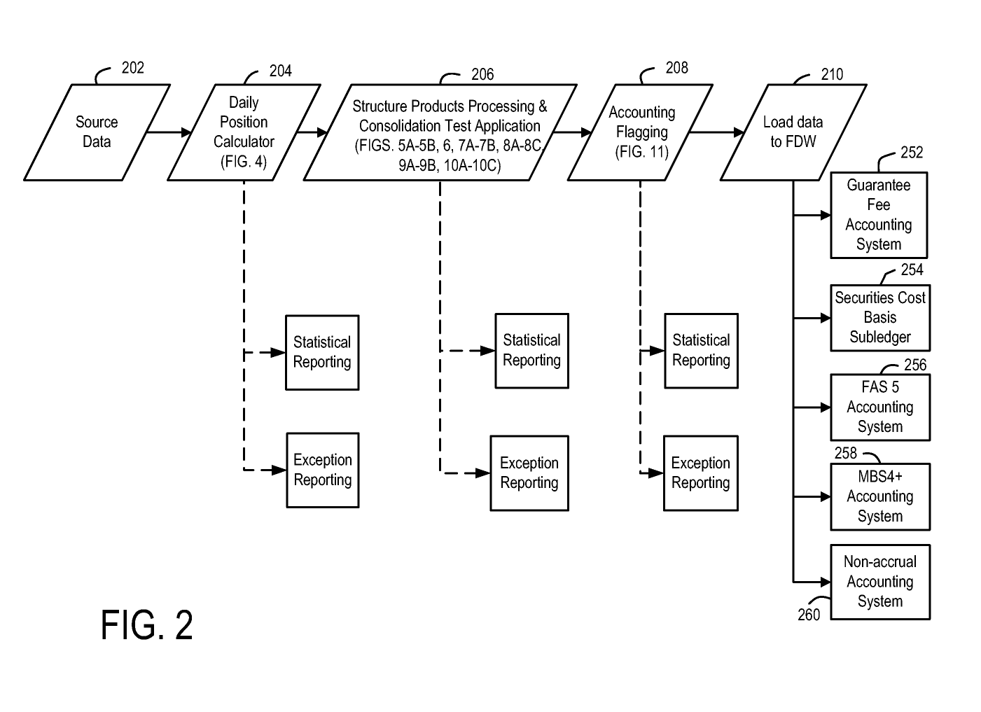

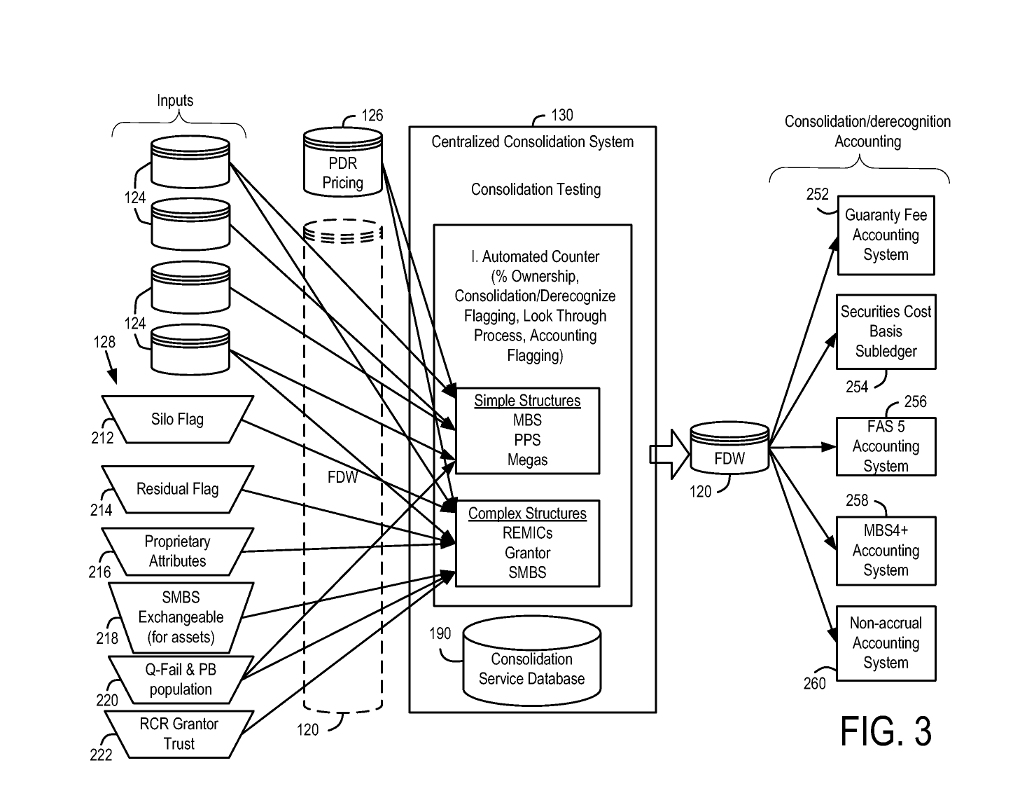

As described in greater detail below, the data processing system 100 generates the consolidation indicators 110 by determining fair value percentage ownership for each financial instrument in a portfolio of financial instruments and by applying consolidation thresholds as prescribed by an accounting policy. The consolidation indicators 110 may, for example, be generated on a regular basis as collateral is purchased and sold out of the retained portfolio of the reporting entity. In an exemplary embodiment, the consolidation indicators 110 are generated on a daily basis. The consolidation indicators 110 may be used to indicate the daily consolidation status of the relevant investment entity (e.g., a trust) to downstream accounting systems 252-260 (FIGS. 2-3). The consolidation indicators 110 may be determined based on the percentage ownership in the financial instrument, various accounting standards and interpretations (e.g., FIN 46(R) and related accounting policies and standards), and so on.

The data processing system 100 includes a financial data warehouse 120 and a centralized consolidation system (CCI) 130. The data warehouse 120 may be a database configured to hold information concerning different financial instruments that may be processed by the consolidation system 130. The financial data warehouse 120 may receive and store daily position information from one or more databases 124 (e.g., different databases associated with different types of financial instruments). Although multiple databases 120, 124, 190 are shown, it will be appreciated that a single database may also be used.

The financial data warehouse 120 may also receive and store accounting treatment indicators 128 from other upstream systems. As described in greater detail below, the accounting treatment indicators 128 may be manually generated and may reflect qualitative assessments including professional accounting judgments that may be exercised in connection with the various financial instruments for which processing is performed.

The information that is received from the instrument-specific databases 124 and the information embodied in the accounting treatment indicators 128 may be received at different times and updated with different frequencies. For example, in an embodiment where the data processing system 100 provides consolidation indicators on a daily basis, at least some of the information from the databases 124 may be updated on a daily basis (e.g., the daily position information for the various securities). On the other hand, the information embodied in the accounting treatment indicators 128 may be updated less frequently (for example, once per quarter, once per annum, etc.) or not updated at all. For example, the information embodied in the accounting treatment indicators 128 may be defined once, e.g., when the financial instrument is created, or when an accounting review is performed, and not thereafter updated.

The consolidation system 130 receives the daily position information and the accounting treatment indicators 128 from the financial data warehouse 120 and processes this information to generate the consolidation indicators 110. The consolidation system 130 comprises an ETL (Extract, Transform, Load) service 170, a consolidation service 180, and a consolidation service database 190.

The ETL service 170 further includes a database read/insert process 172, a daily position calculator 174, a pre-stage data process 176 and a publishing engine 178. The database read/insert process 172 is configured to read data from the database 120 which stores input data for the consolidation system 130. The read/insert process 172 also reads the data in the database 190. The read/insert process 172 also writes data to the databases 120 and 190.

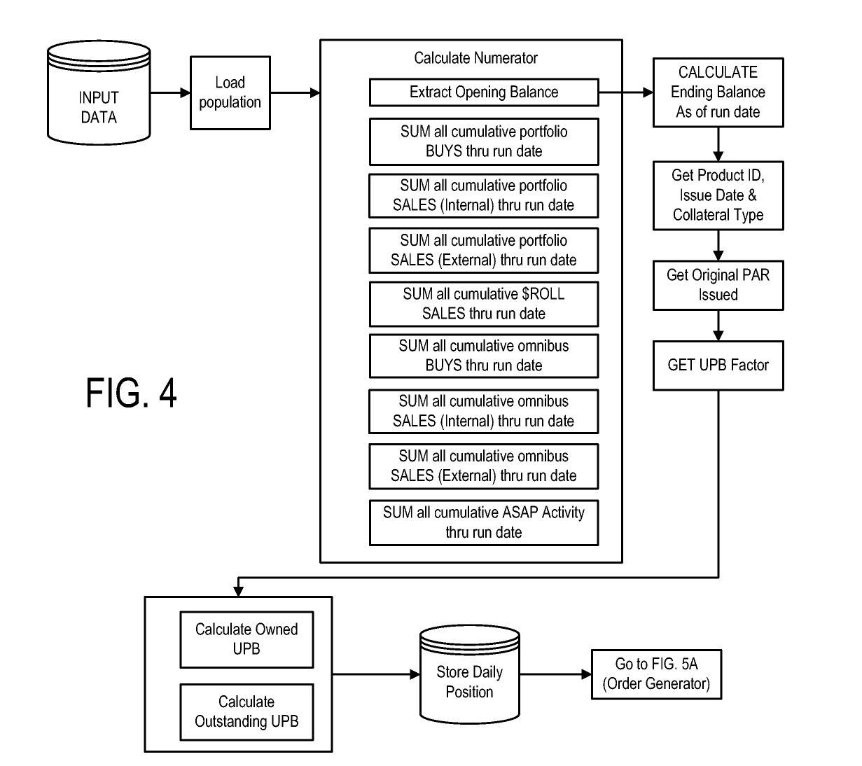

The daily position calculator 174 processes data concerning the financial instruments, including initial security balances and daily trade activity, to calculate the daily final position for the financial instruments. This calculation may be performed each day for each financial instrument. Operation of the daily position calculator 174 is shown in greater detail below in FIG. 4.

The pre-stage data process 176 receives data from the database read/insert process 172 and the daily position calculator 174 and pre-processes data in preparation for the consolidation engine 182. The pre-processing enables the creation of optimal data structures and removes a level of dependence on the data warehouse 120 and other input sources for consolidation processing in the consolidation engine 182 and the REMIC/Mega look-through engine 184. The pre-stage data process 176 denormalizes, aggregates and/or joins multiple sources of data in preparation for the consolidation service 180. The pre-stage data process 176 consolidates sources of data into the structure required for the consolidation database 190, and insulates processing of the consolidation service 180 from the implementation of the interfacing systems. The pre-stage data process 176 also determines the initial ordering of processing by sorting the results from the daily position balance calculation, by date and security type. The pre-stage data process 176 may also perform data cleansing.

The publishing engine 178 publishes final data back to the financial data warehouse 120. For example, the publishing engine 178 makes the final daily indicators 110 available to the financial data warehouse 120. The publishing engine 178 may use the database read/insert process 172 in this process.

The consolidation service 180 is coupled to receive data from the ETL service 170 and further includes a consolidation engine 182, a REMIC/Mega look-through engine 184, an accounting flagging engine 186 and a control reporting engine 188. On a daily basis, the consolidation engine 182 performs “first level” consolidation and determines ownership percentage and applies consolidation tests to each instrument. The consolidation service 180 determines ownership percentage and applies consolidation tests to each CUSIP in the pre-stage data process 176. (“CUSIP” refers to the unique nine-digit number identifying each security, administered by the Committee on Uniform Security Identification Procedures. Herein, the term “CUSIP” is also sometimes used to refer to the security itself.) The consolidation engine 182 is also a controller component and invokes the REMIC/MEGA look-through engine 184 and the accounting flagging engine 186. The consolidation engine 182 starts the process with an order generator and retrieves CUSIP from the consolidation counter (initialized by daily position balances). After conducting a series of tests, including QSPE evaluation tests (Q-fails), ownership percentage test, issue date test, sales thresholds test, as of date test, security type test, etc., a consolidation flag is set for each of the CUSIPs. (An entity that meets the requirement to be treated as sale under FAS 140 is a qualified special purpose entity or “QSPE” and does not have to be consolidiated.)

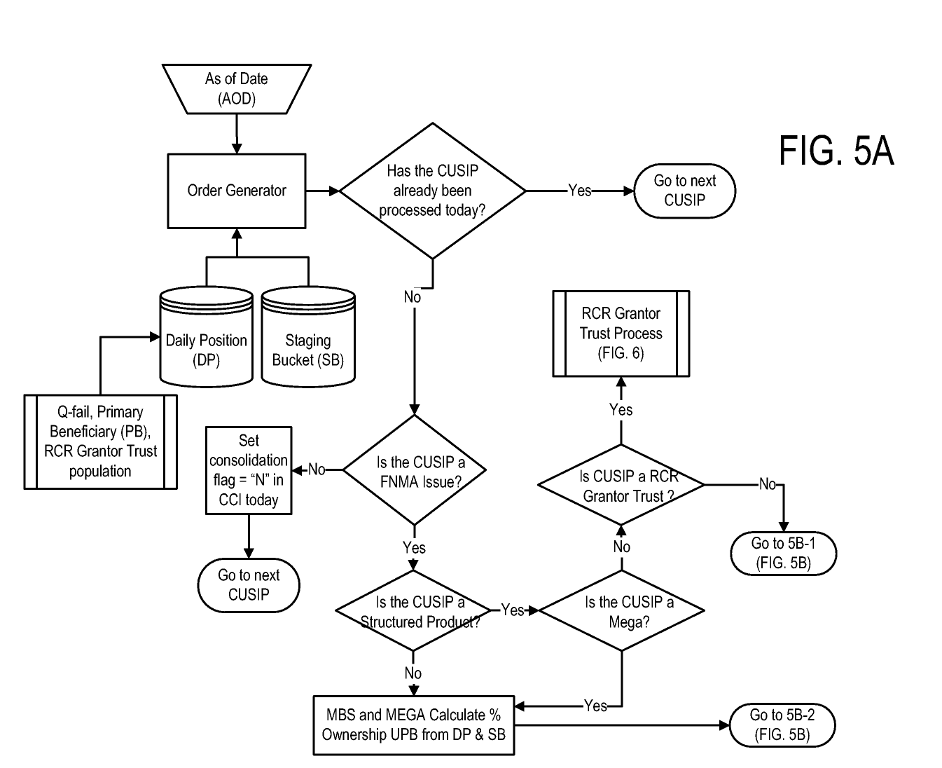

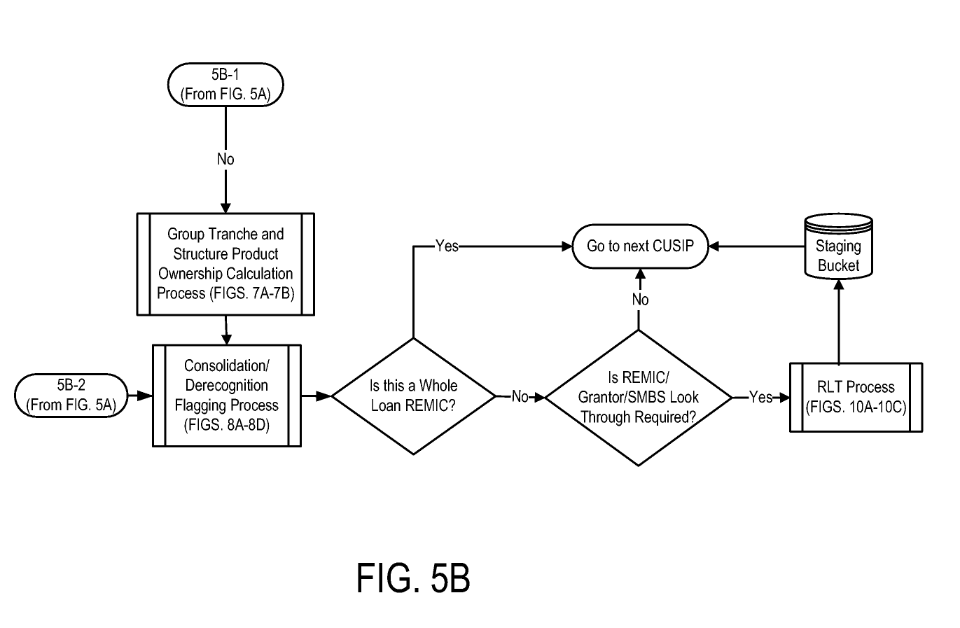

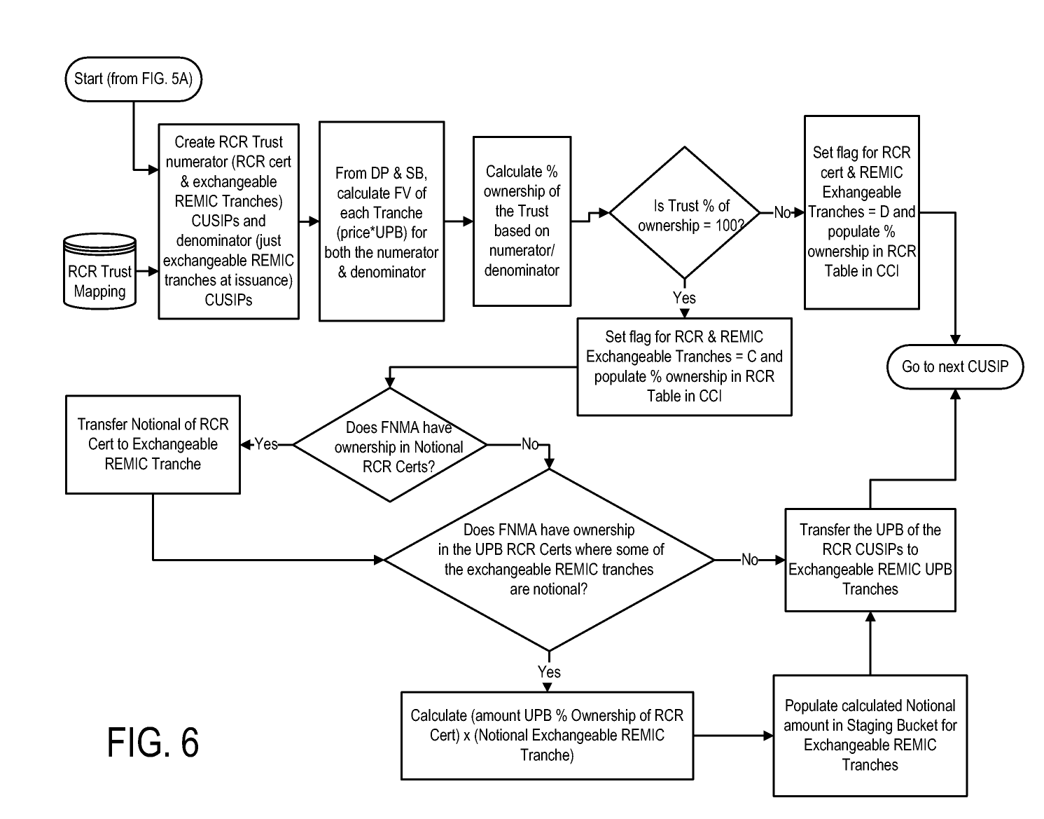

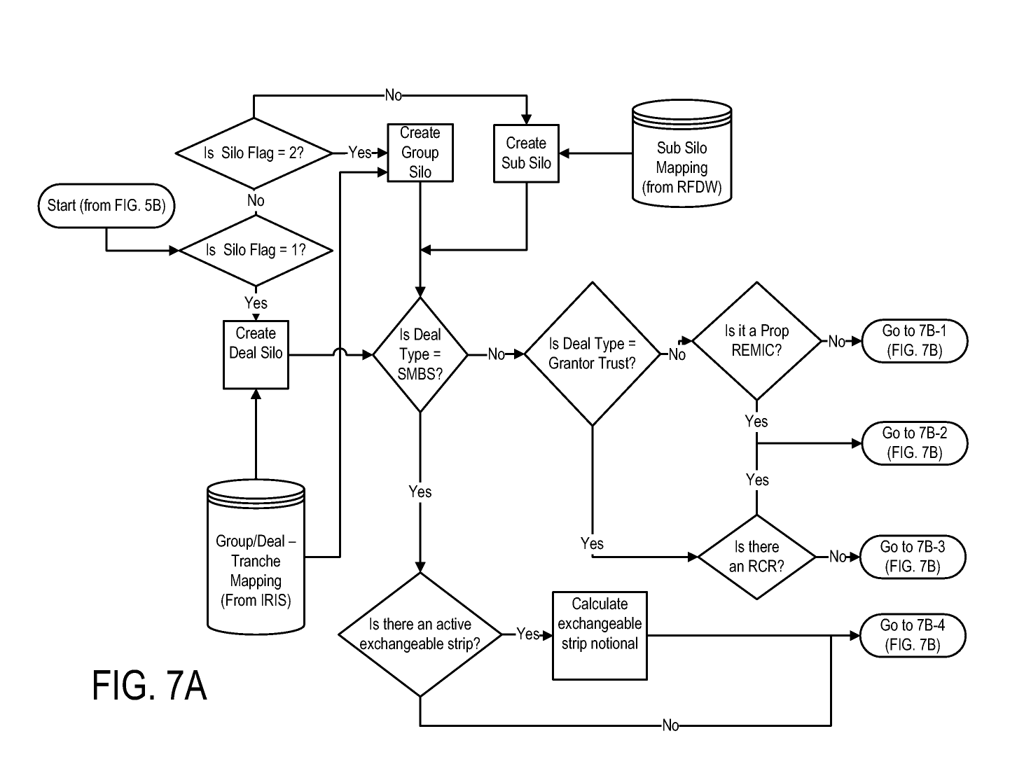

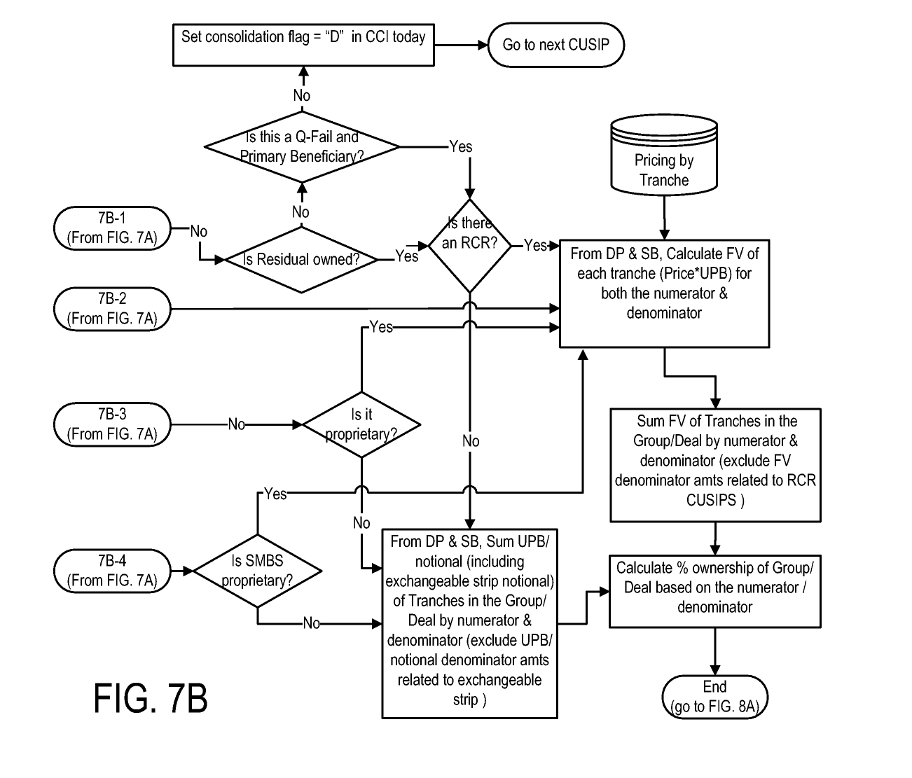

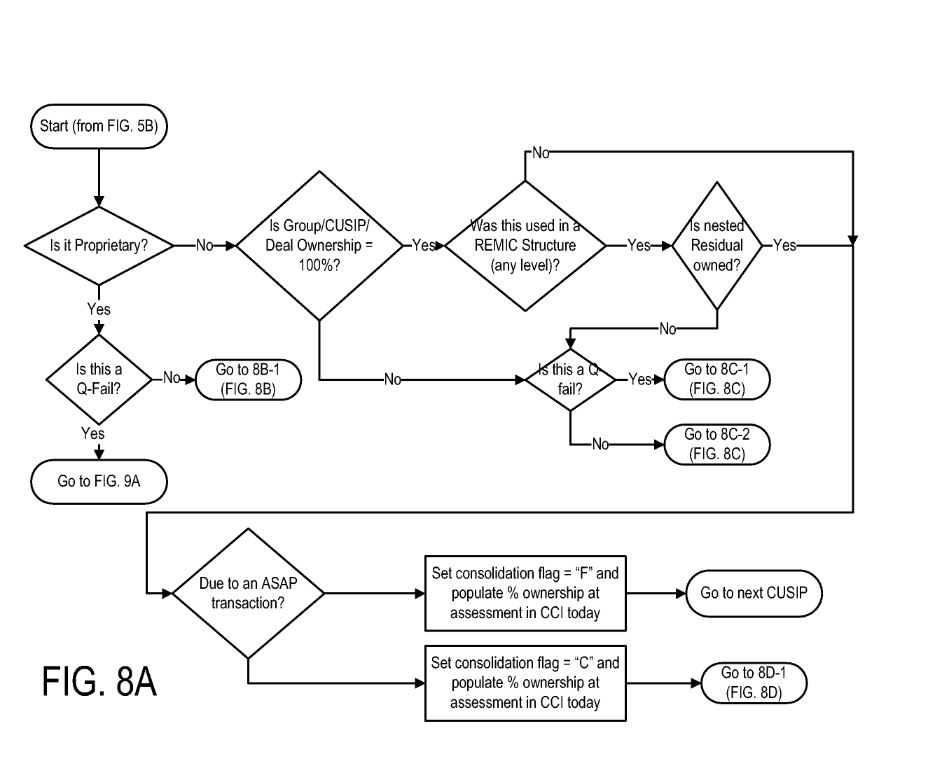

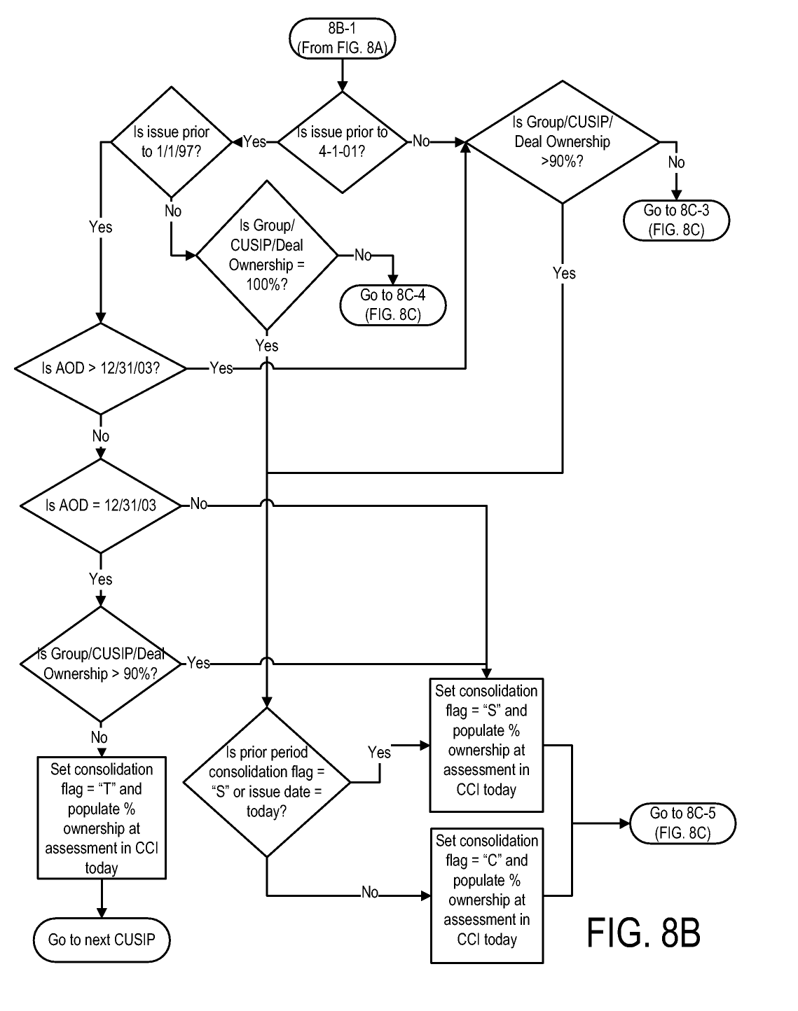

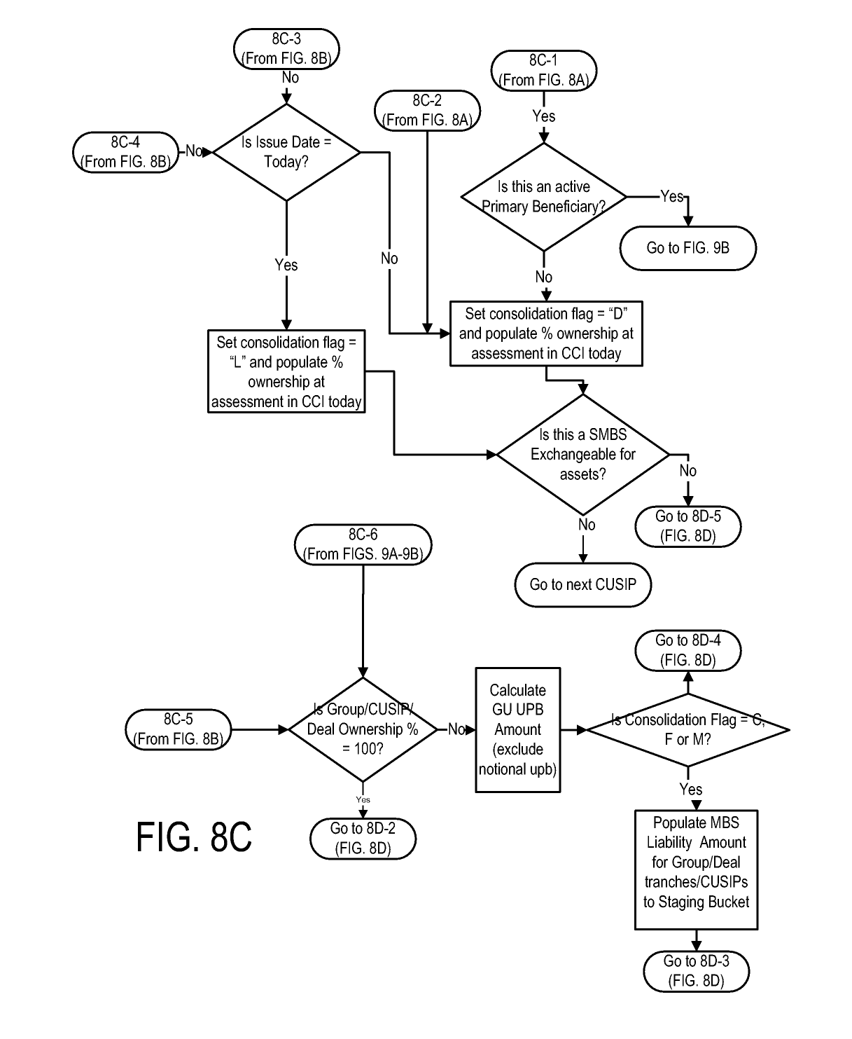

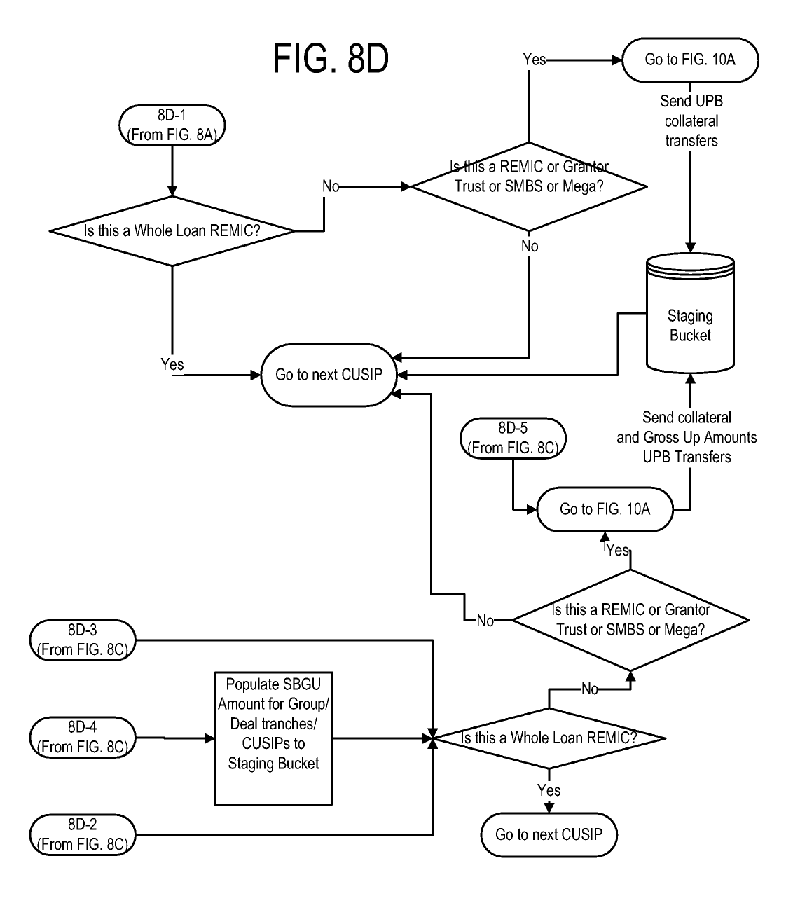

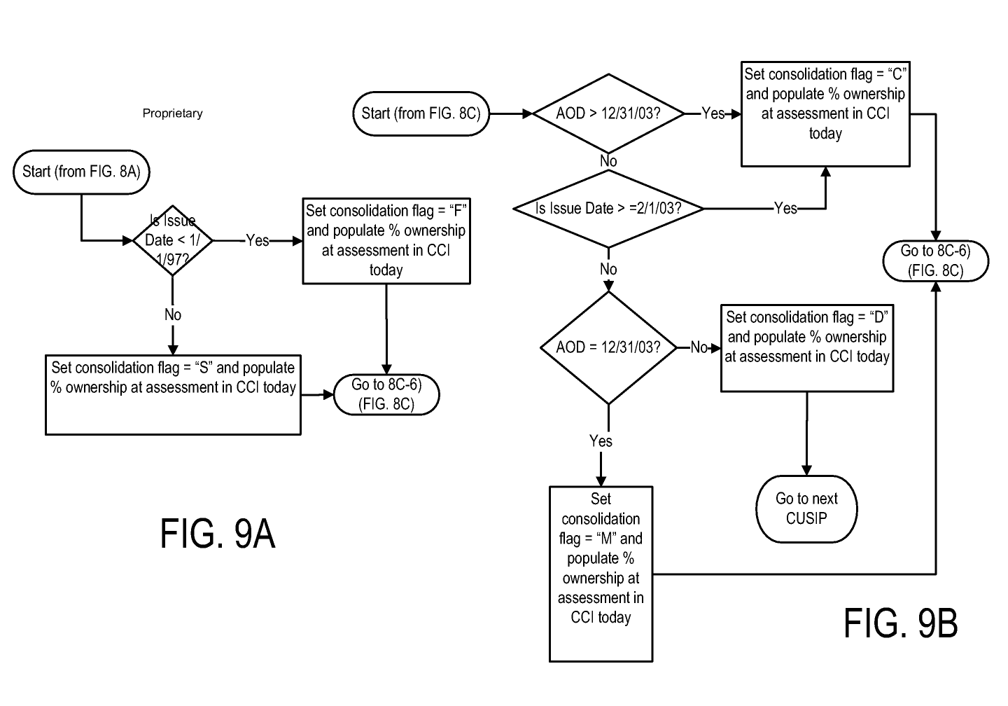

Consolidation decisions are driven by the ownership thresholds as well as by additional thresholds obtained in QSPE and primary beneficiary tests. Ownership percentage calculation is based on the fair value of the retained unpaid principal balance (UPB) of the instrument divided by the fair value of the origination UPB (issuance). UPB amounts are the approximation of the fair value for those securities that do not need to include weighted average amounts in the calculation. Operation of the consolidation engine 184 is shown in greater detail in FIGS. 5A-5B, 6, 7A-7B, 8A-8C, and 9A-9B.

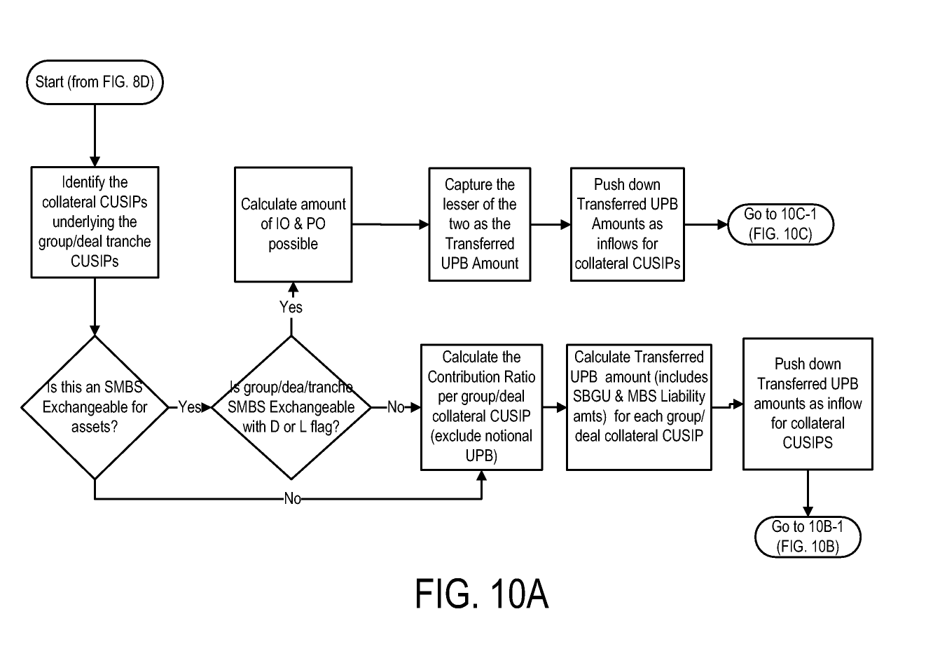

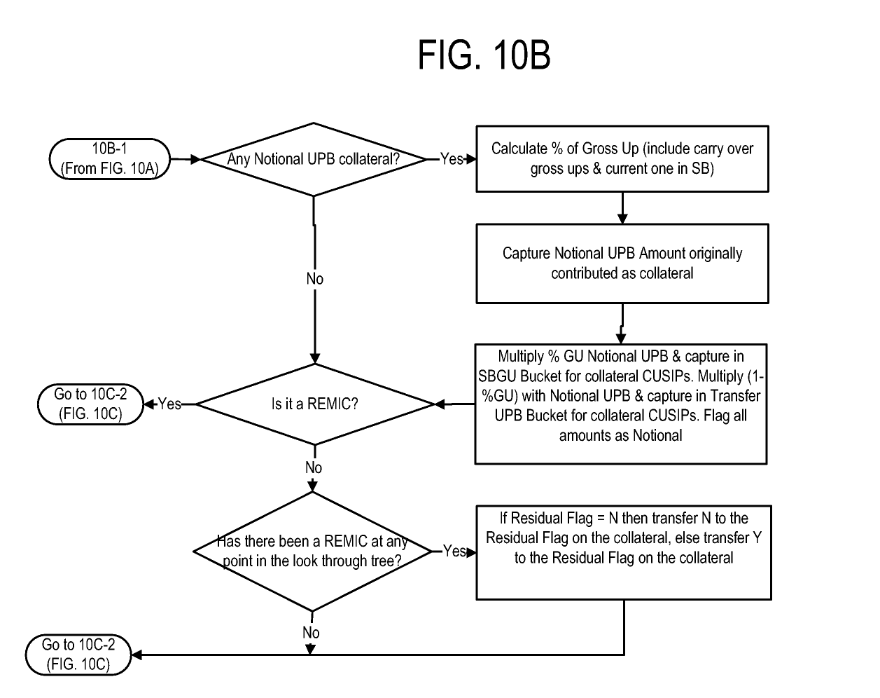

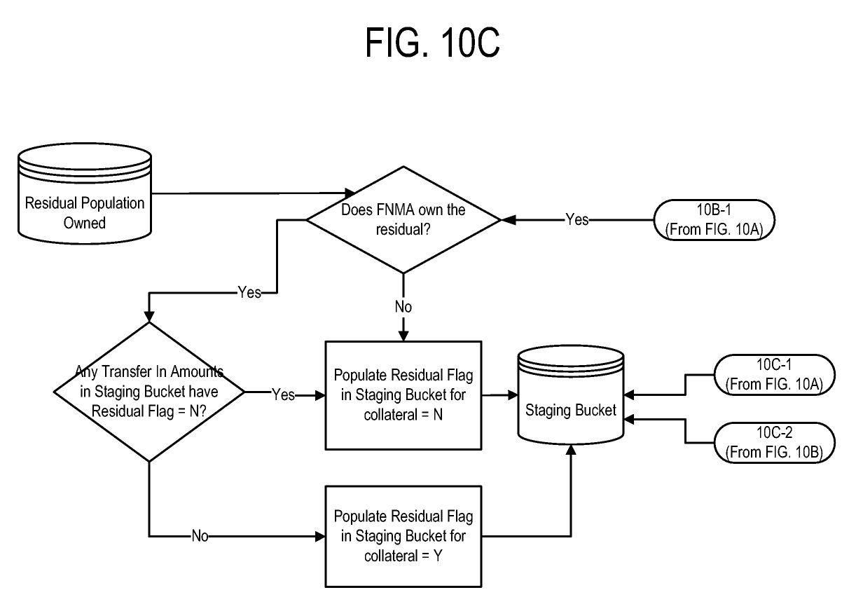

The REMIC/MEGA look-through engine 184 replaces REMIC tranches by the collateral that backs each tranche and transfers the owned UPB of the tranches to the underlying collaterals. Once a REMIC or MEGA has been determined to be consolidated, the consolidation engine 182 uses the look-through tree to identify the underlying collaterals. Additional ownership tests are then performed on each of the collateral pieces to determine if additional consolidation must be performed on these securities. The REMIC/MEGA look-through engine 184 handles MEGA Securities held in portfolio in the similar way. Operation of the REMIC/MEGA look-through engine 184 is shown in greater detail in FIGS. 10A-10C.

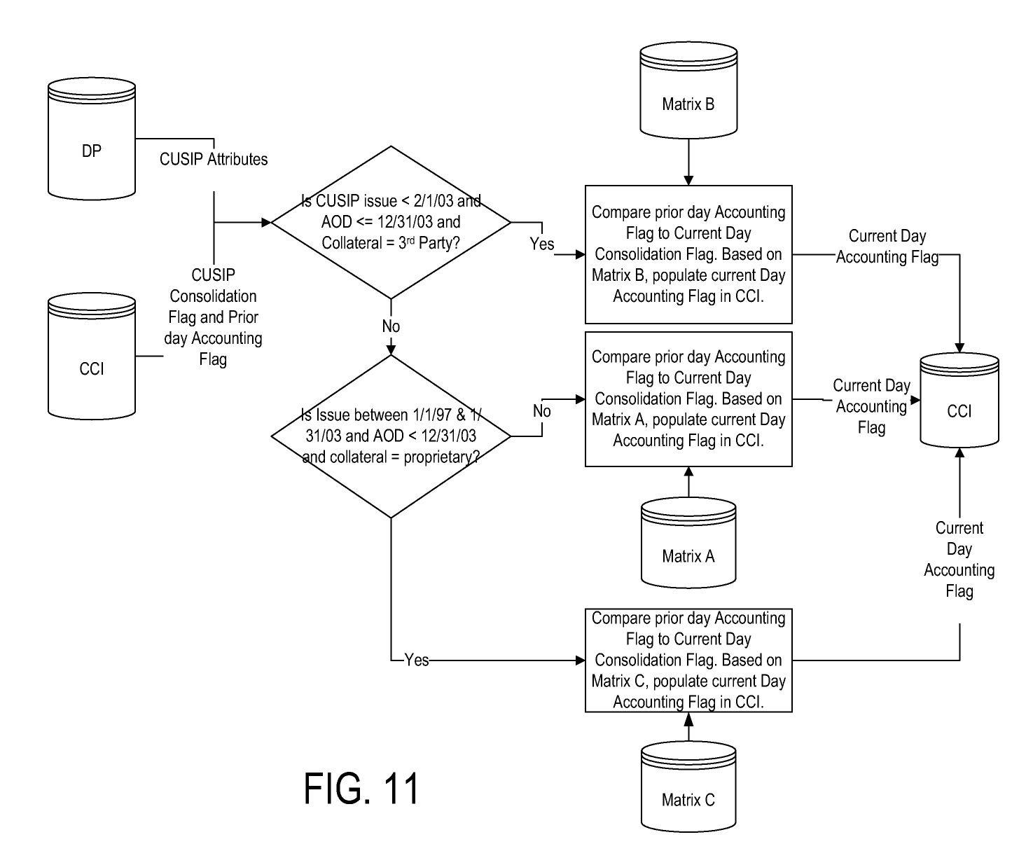

The accounting flagging engine 186 derives the accounting flag for each instrument from the comparison of the current day consolidation flag to the prior day's accounting flag, and based on those two values, populates the current accounting flag based on a predetermined matrix. Operation of the accounting flagging engine 186 is shown in greater detail in FIG. 11.

The control reporting engine 188 provides reports for control and monitoring. Various types of reports may be provided, including upstream data load statistics and exceptions; consolidation process statistics and exceptions; downstream data statistics and reconciliations.

Referring now to FIG. 2, FIG. 2 provides an overview of the operation of the data processing system 100. At step 202, the consolidation system 130 interacts with multiple upstream data sources, all through the financial data warehouse 120. The database bulk read/insert process extracts data from the financial data warehouse 120 and transfers the data to the consolidation service database 190. At step 204, daily position balances are calculated and reference data staged. The consolidation engine 182 sets the consolidation flag for each CUSIP based on consolidation tests and QSPE Evaluation Tests (Q-fails). For REMICs/MEGAs, the look-through engine 184 transfers UPB from tranches to underlying collaterals. At step 208, the accounting flag is derived for each CUSIP from the prior day accounting flag and the current consolidation flag by the accounting flagging engine 186. At step 210, once the data is processed through the consolidation system 130, the output is ready to be written to the financial data warehouse 120. The data is then available to be used by downstream applications 252-260. The control reporting engine 188 may also be used to generate data reports, statistic reports, and exception reports.

Referring now to FIG. 3, FIG. 3 shows the flow of information through the consolidation system 130 in greater detail according to one embodiment. As a general matter, as shown in FIG. 3, the consolidation system 130 receives inputs (shown generally on the left side of FIG. 3), performs processing on the inputs (using logic depicted generally in the middle of FIG. 3), and generates outputs delivered to downstream accounting systems (shown generally on the right side of FIG. 3). Detailed examples of the inputs and outputs is provided below, e.g., in the form of various tables and other information. A detailed example of the processing that may be performed by the consolidation system 130 is shown in FIGS. 4, 5A-5B, 6, 7A-7B, 8A-8C, 9A-9B, 10A-10C, and 11. As will be appreciated, while detailed examples are provided, the set of inputs and outputs to the consolidation system 130, as well as the processing performed by consolidation system 130, is dependent on accounting standards, interpretations, policies and practices, which may change over time. Accordingly, while one detailed example is provided, it will be appreciated that other embodiments that receive different inputs, perform different processing on the inputs, and generate different outputs are also possible.

As previously mentioned in connection with FIG. 1, the consolidation system 130 utilizes daily inventory position as well as the population of instruments in the investment portfolio subject to the consolidation tests. Monthly data may also be used to determine the unpaid principal balance (UPB) and a REMIC Map. In addition, a pricing data repository (PDR) 126 may be used to provide daily prices for one or more of the instruments (e.g., REMICs).

As previously mentioned, the consolidation system 130 may receive information concerning a variety of different types of fungible financial instruments from one or more databases 120. For example, information may be received concerning various proprietary instruments (e.g., proprietary Megas, proprietary REMICs, proprietary grantor trusts, proprietary SMBSs, proprietary wraps on private label REMICs, proprietary whole loan REMICs, and so on). Additionally, information may be received concerning various non-proprietary instruments (e.g., SWAPs, dealer Megas, dealer REMICs, dealer grantor trust, dealer SMBS, dealer whole loan REMICs, private label REMICs flagged as QSPE test fail (Q fail) and Primary Beneficiary, dealer DMBS. and so on). A financial instrument is considered “proprietary” to a reporting entity based on whether the reporting entity transfers the collateral from its own portfolio to the trust or other entity that is created when creating the financial instrument. For proprietary instruments, ownership is assumed to be demonstrably distinct. As will be appreciated, data concerning other financial instruments may also be received, depending on the financial instruments that are held in the investment portfolio of the reporting entity.

The following tables provide examples of data that may be received from the financial data warehouse 120. As will be appreciated, the data that is received will be dependent on a variety of factors, including the securities that are held in the investment portfolio, the accounting that is performed, and so on.

TABLE A1
Data received from data warehouse 120 regarding
opening inventory balance position

| Business Data Element | |
|---|---|
| Field | Comments |
| CUSIP | Nine digit security identifier |
| Balance Date | Default this date to opening date |
| | (e.g., Mar. 31, 2001) |
| Par Amount | Par Amount of the still in position. Only include |
| | records where the UPB is greater than zero. |
| Current UPB | Unpaid principal balance on opening date |
| Expectation Reference | Expectation Reference Number |
| No | |
| Piece Sequence No | Piece Sequence Number |
| Trade Disclosure Code | This indicates STIS |

TABLE A2
Data received from data warehouse 120 regarding
portfolio purchases, internal portfolio sales, external portfolio sales,
portfolio dollar roll sales, omnibus sales, and omnibus purchases
(post-trade support).

| Business Data | |
|---|---|
| Element Field | Comments |
| CUSIP | Nine digit security identifier |
| Trade Number | Trade Number on the transaction |
| Trade Treatment Code | Code provided to FDW from a data team; indicates |
| | what type of purchase the trade is. |
| Re-securitization ID | Code that identifies re-securitizations and helps mapping |
| | to the underlying collateral. |
| Wire Date | Date of the actual wire transfer. (Time stamps not used.) |
| | For collateral used in resecuritization transactions, this date |
| | will be changed to equal the date of the newly formed securities |
| | wire date into portfolio or CSTD (whichever is first). |
| Wire Id | Identifies wire ID in STAMPs in pre-trade support, if |
| | available |
| Par Amount | Par Amount of the CUSIP |
| Expectation Reference | Expectation Reference Number of the Purchase |
| No | |
| Piece Sequence No | Piece Sequence Number of the Purchase |
| Trade Type Code | Identify internal trades or external trades. |
| Trade Disclosure Code | This indicates STIS |
| Dollar Roll restatement | This code identifies the restatement treatment for dollar |
| code | roll transactions for internal portfolio sales. |

TABLE A3
Data received from data warehouse 120 regarding
Actual CUSIP Balances for CUSIPS in the CSTD Account as of
Dec. 31, 2001

| Business | |
|---|---|
| Data Element | |
| Field | Comments |
| CUSIP | Nine digit security identifier |
| As of Date | Date set to Mar. 31, 2001 |
| Subacct | The Fed subaccount. This will be CSTD for this request. |
| Par Balance | The total PAR balance for the CUSIP as of COB on |
| | Mar. 31, 2001. |

TABLE A4
Data received from data warehouse 120 regarding
omnibus purchases and sales (pre trade support)

| Business Data | |
|---|---|
| Element Field | Comments |
| CUSIP | Nine digit security identifier |
| Wire Date | Date of the actual wire transfer. Do not include time |
| | stamps. |
| CCI Wire Date | If the wire date is identified after the issuance |
| | month, use the CCI wire date (for omnibus sales) |
| Par Amount | Par Amount of the CUSIP |
| Sale Expectation | Expectation Reference Number of the Sale |
| Reference No. | |
| Wire ID | Unique Identifier for Wire |
| Wire Id | Identifies wire id in STAMPs in pre-trade support |
| Trade No. | Unique Identifier for Trade |
| Sender Sub Account | Account from which the wire is being sent |
| Send Receive | Indicator to which wire is being sent and received |
| Indicator | |

TABLE A5
Data received from data warehouse 120 regarding
portfolio monthly balances

| Business Data | |
|---|---|
| Element Field | Comments |
| CUSIP | Nine digit security identifier |
| Balance Date | Get this for each month from Apr. 01, 2001 to |
| | Dec. 31, 2004. |
| Par Amount | Par Amount of the still in position. Only include records |
| | where the UPB is greater than zero. |
| Current UPB | This is unpaid principal balance on Dec. 31, 2001. |
| Trade | This indicates STIS |
| Disclosure ID | |

TABLE A6
REMIC look-through data received from data warehouse
120

| Data Attribute | Description |
|---|---|
| Node Identifier | Node Identifier |
| Collateral CUSIP | The CUSIP that identifies the collateral |
| | supporting the REMIC. |
| Accounting Period | Accounting Period |
| Parent Deal Name | Deal Name |
| Parent Deal Group Identifier | Deal Group ID |
| Collateral CUSIP UPB in | The amount of UPB of the Collateral |
| Group | CUSIP in the Group on the as of date. |
| Collateral CUSIP Current | The total UPB of the Collateral CUSIP on |
| UPB | the as of date. |
| Collateral CUSIP UPB | The percentage of UPB of the Collateral |
| Percent in Group | CUSIP in the Group on the as of date. |

TABLE A7
MEGA look-through data received from data warehouse
120

| Data Attribute | Description |
|---|---|
| Mega Node Identifier | Month and year of the look-through data is |
| | effective. |
| Collateral CUSIP | The CUSIP of the Fannie Mae Collateral |
| | Security. |
| As of Date | Effective date of the look-through Data. |
| Parent (MEGA) CUSIP | The CUSIP that identifies the parent (mega). |
| Collateral CUSIP UPB | The amount of UPB of the Collateral CUSIP in |
| in MEGA | the MEGA on the as of date. |
| Collateral CUSIP | The total UPB of the Collateral CUSIP on the |
| Current UPB | as of date |
| Collateral CUSIP % in | The percent in UPB of the Collateral CUSIP in |
| MEGA | the MEGA. |

As will be appreciated, other data may also be received from the financial data warehouse 120. Examples of such data may include MBS issued balance data (to identify MBS Issued Par Balances to be used in calculating percentage ownership of MBS purchased, sold, and held in inventory (percentage ownership will determine which securities will need to be consolidated under FIN 46), to identify which MBS securities are Lender Formed (SWAP) or reporting entity Formed (OOP) pools, to identify which MBS securities are MEGA pools, and so on), REMIC issue balance and attribute data (to identify each Fannie Mae REMIC (including all Structured Deals) issued and the complete list of Tranche CUSIPS that are issued from each Deal, to identify the Issue PAR amount for each Tranche CUSIP, including the notional issue par amount for securities with notional balances, and so on). REMIC factor data (to identify current UPB balances for the outstanding Tranche CUSIPS, and the effective date of the UPB Balances, needed to identify Tranches within a group that have active UPB balances to calculate group percent ownership), MBS factor data (to identify current UPB balances for the outstanding MBS CUSIPS, (including MBS, MEGA, and PPS securities), and the effective date of the UPB Balances), proprietary pricing requirements (to get daily fair market value prices, which are required to perform consolidation tests on proprietary structured products (specifically REMICS, GRANTORS, and SMBS)), other sale data requirements such as as-soon-as-pooled sale data requirements, and so on.

The consolidation system 130 also receives accounting treatment indicators 128 from the financial data warehouse 120. In one embodiment, these indicators include a silo indicator 212, residual indicator 214, proprietary attributes indicator 216, an exchange SMBS indicator 218, Q-fail and primary beneficiary population indicator 220, and RCR grantor trust indicator 222. As will become apparent below, the indicator may be any data (e.g., a flag, a data structure such as a table, etc.) that provides information about accounting treatment. Although certain types of indicators of indicators are described below, other indicators may also be used.

The silo indicator 212 reflects the results of a manually-performed qualitative analysis performed in connection with REMIC deals to determine whether to assess percentage ownership and the related consolidation/derecognition flagging at the silo (group) level or at the deal level (entire REMIC structure) or at the subsilo level. There is a manual effort to map the subsilos to specific CUSIPS. Based on the manual effort, a qualitative determination is made by REMIC which ones are to be assessed at which level. The results of the analysis are captured by the silo indicator 212 and stored in the financial data warehouse 120 for consumption by the consolidation system 130.

The information contained in the silo indicator 212 is shown in the table below:

TABLE B1(a)
Data contained in the silo indicator

| | | Null/ | |
|---|---|---|---|
| Data | | Not | |
| Attribute | Description | Null | Format |
| Silo Flag | Indicator on whether to assess the deal | Not Null | Char(1) |
| | at the silo (2) or deal (1) or subsilo (3) | | |
| | level | | |
| Subsilo ID | Indicator populated when Subsilos are | Null | Number |
| | being used. | | (2, 0) |
| CUSIP | Security CUSIP Indicator | Not Null | Char(9) |

For the CUSIPS that have a Silo Flag=3 (deal assessed at subsilo level), a second table captures the mapping of parent CUSIPS for subsilos to their underlying collateral CUSIPS. This mapping may be performed manually.

TABLE B1(b)
Additional data contained in the silo indicator where
deal is assessed at subsilo level

| | | Null/ | |
|---|---|---|---|
| Data Attribute | Description | Not Null | Format |
| Parent CUSIP | Security CUSIP Indicator | Not Null | Char(9) |
| Collateral CUSIP | Security CUSIP Indicator | Not Null | Char(9) |
| % Contributed to | % of Par of the Collateral | Not Null | Number |
| CUSIP | CUSIP that was contributed to | | (14, 10) |
| | the parent CUSIP | | |
| PAR Contributed | Par amount of the Collateral | Not Null | Number |
| | CUSIP that was contributed to | | (15, 2) |
| | the parent CUSIP | | |

The residual indicator 214 is associated with REMICS for all the non-economic residuals that the reporting entity owns. The residual indicator 214 may, for example, be in the form of a flag having a null/not null status indicating that the reporting entity is the residual owner for the REMIC. This information may be used because the reporting entity must have unilateral control of a dealer REMIC (and other non-proprietary security types) in order to collapse it (consolidation) and look-through to the underlying collateral. Unilateral control includes owning the non-economic residual. Additionally, the non-economic residual is required to be owned by the reporting entity related to the REMIC in order for any underlying lender swap collateral to be consolidated (all levels). The non-economic residual may specifically relate to a group, a number of groups, or the whole REMIC deal. Due to these possibilities, the data warehouse 120 captures the residual indicator 214 at the tranche CUSIP level.

The proprietary attributes indicator 216 indicates whether the instrument is proprietary. A financial instrument is considered “proprietary” to a reporting entity based on whether the reporting entity transfers the collateral from its own portfolio to the trust or other entity that is created when creating the financial instrument. The proprietary attributes indicator 216 may, for example, be in the form of a flag having a null/not null status indicating whether the reporting entity is transferor of the collateral. The consolidation system 130 applies logic based on many different factors, including whether the security/product that is being assessed is proprietary or non-proprietary. In general terms, proprietary securities/products are assessed with a 90% threshold. Non-proprietary products are assessed at 100% ownership to be consolidated. For MBS, loans may be transferred from portfolio to the trust in order for the security to be proprietary. For structured products, the underlying collateral transferred to the deal must have at least one piece come from the reporting entity's portfolio to be considered proprietary. In an exemplary embodiment, all structured product CUSIPs are manually flagged either proprietary or non-proprietary, and these indicators 216 are captured in the data warehouse 120.

The exchangeable SMBS indicator 218 indicates whether the SMBS is exchangeable for assets. Some SMBS deals have a feature that allow the owner(s) of the class CUSIPS that are issued to exchange those in for a proportionate share of the actual underlying assets (i.e. Mega, MBS, etc). Because of this feature, it may be desirable for the consolidation system 130 to include its proportionate ownership of the underlying MEGA certificate in the consolidation system 130 for ownership when assessing the ownership of the MEGA trust for the purpose of consolidation. (This feature is different from another common feature in SMBS deals that allows for the exchanging of classes for other classes with different coupon rates.) To generate the flag, a manual assessment may be performed on all SMBS deals in the investment portfolio to determine which individual deals have this feature and which do not have this feature. The exchangeable SMBS indicator 218 may, for example, be in the form of a flag having a null/not null status indicating whether the SMBS deal has the above-described feature.

The Q Fail and Primary Beneficiary indicator 220 reflects a qualitative assessments of the QSPE Evaluation Tests (“Q-fails”) and related Primary Beneficiary designations (“PB designations”). (“Q-Fail” refers to a security that fails the qualified special purpose entity (QSPE) evaluation test.) Structured product deals and or groups may be manually flagged as a Q Fail or primary beneficiary. The assessment is performed on a population of at risk trusts that may need to be consolidated (Fail QSPE status) based on qualitative factors other than just percent ownership. The Q Fail indication overrides any assessment the consolidation system 130 may have originally made. The results of the assessment is provided to the consolidation system 130 to process with the entire population of financial instruments. The consolidation system 130 incorporates the impact of the Q-fails and PB designations inputs into the overall process and stores the results and supplies downstream users with the associated accounting treatment flag.

The data elements that are captured in the financial data warehouse 120 in a structured product static table at deal or group level are as follows:

TABLE B2
Data contained in the Q Fail and Primary Beneficiary
indicator

| | | Null/ | |
|---|---|---|---|
| | | Not | |
| Data Attribute | Description | Null | Format |
| Deal ID | Identifies the Deal | Not | Character |
| | | Null | |
| Group Number | Identifies the group within the deal | Not | Number |
| | | Null | |
| Tranche CUSIP | Security CUSIP Indicator | Not | Char(9) |
| | | Null | |
| Q Fail Flag | Indicates whether the group/deal is | Null | Flag |
| | a Q Fail | | |
| Primary | Indicates whether the group/deal is | Null | Flag |
| Beneficiary | the primary beneficiary of a Q Fail | | |
| Flag | | | |
| Q Fail Effective | Indicates the date the deal/group | Null | Date |
| Date | became a Q Fail | | |
| PB Effective Date | Indicates the date the deal/group | Null | Date |
| | became a PB | | |
| Record Effective | Date that the record was populated | Not | Date |
| Date | in the table | Null | |
| Record Expiration | Date that the record was no longer | Null | Date |
| Date | valid and replaced with a new one. | | |
| Source Record | Identifies the source system (MF | Not | Number |
| | Model, SF Model, etc) | Null | |

The RCR grantor trust indicator 222 reflects an RCR Trust to Class mapping that is performed. RCRs are evaluated as separate entities. The results of the mapping are captured in the data warehouse 120 for consumption by the consolidation system 130. The data elements that are captured in the financial data warehouse 120 are as follows:

TABLE B3
Data contained in the RCR grantor trust indicator

| | | Null/ | |
|---|---|---|---|
| | | Not | |
| Data Attribute | Description | Null | Format |
| Recombination Number | Identifies recombination | Not Null | Numeric(15, 0) |
| REMIC Deal Name | Identifies the Deal | Not Null | VarChar(30) |
| Accounting Period | Month, day, year of transaction | Not Null | DATE |
| Recombinable Class | Identifies the Recombinable | Not Null | VarChar(20) |
| | Class | | |
| Recombinable Class | Recombinable CUSIP Indicator | Not Null | Char(9) |
| CUSIP | | | |
| Recombinable Class | UPB of the Recombinable Class | Not Null | Numeric(20, 2) |
| Balance | | | |
| Exchangeable Class | Identifies the Exchangeable | Not Null | VarChar(20) |
| | Class | | |
| Exchangeable Class | Exchangeable CUSIP Indicator | Not Null | Char(9) |
| CUSIP | | | |
| Exchangeable Class | UPB of the Exchangeable Class | Not Null | Numeric(20, 2) |
| Balance | | | |
| Exchangeable Percent | Percentage of contribution from | Not Null | Numeric(14, 10) |
| Allocation | Exchangeable tranche to | | |
| | Recombinable tranche | | |
| Balance Type of | Principal or notional | Not Null | TBD |
| Exchangeable Class | | | |

The consolidation service 130 processes the data from the financial data warehouse 120 to generate consolidation indicators 110 which provide downstream accounting systems with ownership and consolidation status information for instruments in the portfolio of investments. The operation of the consolidation service 130 is shown by way of example in FIGS. 4, 5A-5B, 6, 7A-7B, 8A-8C, 9A-9B, 10A-10C, and 11. As previously indicated, the processes shown in FIGS. 4, 5A-5B, 6, 7A-7B, 8A-8C, 9A-9B, 10A-10C, and 11 are dependent on accounting standards, interpretations, policies and practices which may change over time. Accordingly, the processes shown are merely one example.

Based on the data received from the financial data warehouse 120 and the accounting treatment indicators 128, various tables may be constructed and stored in the consolidation service database 190. For examples, tables such as upstream FDW interface tables, upstream PDR interface tables, tables with data originated from spreadsheet, consolidation process tables, and so on may be constructed. As an example, a REMIC node table may be constructed which contains REMIC look-through data including the collaterals for REMICs. Likewise, a MEGA pool node table may be created which contains MEGA look-through data including the collaterals for MEGAs. As another example, a security consolidation aggregate table may be constructed that stores the results of consolidation engine process, REMIC/MEGA look-through, and accounting flagging process. This table is referred to as the “CCI bucket” in FIG. 5A to FIG. 11. As another example, a security consolidation detail table may be created which includes detailed transactions of REMIC/MEGA look-through, including every UPB, SBGU transaction—transferring out of parent node and transferring into children nodes. This table is referred to the “staging bucket” in FIG. 5A to FIG. 11. A central consolidation indicator matrix table may also be constructed which stores the accounting matrix A, B, and C used for accounting flagging, shown in FIG. 11.

The consolidation service 130 generates various outputs, including consolidation indicators and other outputs. The consolidation indicators 110 may be any data (e.g., a flag, a data structure such as a table, and so on) that provides consolidation status information. For example, consolidation indicators 110 may be in the form of accounting status flags that indicate the consolidation status of the security. Outputs of the consolidation system 130, including such accounting status flags, are shown in the tables below:

TABLE C1
Consolidation Service 130 Daily Flagging to FDW

| Business | |
|---|---|
| Data Element | |
| Field | Description |
| CUSIP | Nine digit security identifier |
| Accounting | Current accounting period - Accounting Month and Year |
| Period | |
| Accounting | Indicates the FIN 46 consolidation status of the CUSIP. Values as |
| Status Flag | shown below: |
| | “S” - Secured borrowing |
| | “C” - Consolidate at Fair Value |
| | “L” - First time % Ownership <= 90% |
| | “D” - Derecognize |
| | “R” - Continuous Consolidation |
| | “N” - Never Consolidated or continuous derecognition |
| | “P” - Continuous Secured Borrowing |
| | “F” - Consolidate at Book Value |
| | “T” - Transition for Pre 1997 originated PPS CUSIPs @ AOD |
| | Dec. 31, 2003 |
| | “M” - Transition at Dec. 31, 2003 for Qfail/PB CUSIPs |
| Transaction | Date of the accounting status flag application-effective day of FIN 46 |
| Date/Effective | event |
| Date | |
| Loan | Indicates the FAS65 Designation Code of the CUSIP. |
| Designation | Valid values: HFS (held for sale), HFI (held for investment) |
| Code | Logic: If security type = MBS and Collateral Type is Proprietary then |
| | set to HFS otherwise HFI. |
| UPB Owned | Amount of UPB that the reporting entity (“FNMA” in FIGS. 4-11) |
| | owns. This UPB includes daily position, transfers, and all gross-ups. |
| Daily Position | Amount of UPB owned in the portfolio before any transfers. |
| UPB | |
| Transferred | Amount of UPB transferred from the look-through process |
| UPB | |
| SBGU UPB | UPB pushed down as secured borrowing |
| MBS Liability | UPB pushed down as minority interest |
| Gross Up UPB | |
| Par Owned | Amount of Par that the reporting entity owns. This Par includes daily |
| | position, transfers, and all gross-ups. |
| Transferred Par | Amount of UPB transferred from the look-through process. This is |
| | calculated as follows: Transferred UPB/Current month factor. |
| SBGU Par | Par gross up as secured borrowing. This is calculated as follows: |
| | SBGU UPB/Current month factor. |
| MBS Liability | Par gross up as minority interest. This is calculated as follows: MIGU |
| Gross Up Par | UPB/Current month factor. |
| UPB | Total outstanding UPB on the CUSIP. This is calculated in CCI and |
| Outstanding | should be provided directly to downstream users from CCI. |
| ASAP Flag | Indicates if this is an ASAP CUSIP. Set to yes if there was ever ASAP |
| | activity captured. |
| % Ownership | CCI generated % of security value owned by The reporting entity |
| CSTD Daily | Daily par balance in the CSTD account to support pre-trade support |
| Par Balance | data model |
| (Omnibus) | |
| CSTD Daily | Daily UPB balance in the CSTD account to support pre-trade support |
| UPB Balance | data model. |
| (Omnibus) | |
| ASAP daily Par | Daily ASAP Par balance to support pre-trade support data model. This |
| balance | represents the daily balance in the ASAP bucket before it moves into |
| | CSTD or Portfolio. |
| ASAP Daily | Daily ASAP UPB balance to support pre-trade support data model. |
| UPB balance | This represents the daily balance in the ASAP bucket before it moves |
| | into CSTD or Portfolio. |
| % of Actual | % of ownership based on the actual owned UPB in the Portfolio |
| Ownership | without gross up |
| Actual UPB | Amount of UPB owned without gross up |
| owned | |

TABLE C2
Consolidation Services Look-through Data (“Staging
Bucket”) to FDW (provides the one level down look-through)

| Business | |
|---|---|
| Data Element | |
| Field | Description |
| CUSIP | Nine digit security identifier |
| Transaction | Date of the accounting status flag application-effective day of FIN 46 |
| Date/Effective | event |
| Date | |
| UPB | UPB of the CUSIP transferred. Does not include the minority |
| | interest or secured borrowing gross up amount. The parent would |
| | have negative UPB and the children would have positive UPB. |
| Secured | UPB considered secured borrowing or minority interest (allocated |
| Borrowing | from parent). Net secured borrowing transferred from the parent to the |
| UPB | children. |
| MBS Liability | Minority UPB generated for consolidated proprietary products. Net |
| Gross Up UPB | amount transferred. |
| Par | Par of the CUSIP transferred. Does not include the minority interest |
| | or secured borrowing gross up amount. The parent would have |
| | negative Par and the children would have positive Par. This is |
| | calculated as follows: UPB (above)/Current Month Factor |
| Secured | UPB considered secured borrowing or minority interest (allocated |
| Borrowing Par | from parent). Net secured borrowing transferred from the parent to |
| | the children. This is calculated as follows: Secured Borrowing UPB/ |
| | Current Month Factor |
| MBS Liability | Minority UPB generated for consolidated proprietary products. This |
| Gross Up Par | is calculated as follows: MIGU UPB/Current Month Factor |
| Parent/Child | Parent or child indicator. If the transfer amount is positive it is the |
| indicator | child, negative it is the parent. |
| From CUSIP or | This is the field that holds the MEGA or group being transferred from. |
| REMIC/group | |
| ID | |
| FV Price | Fair Value Price of the Security only if it is a proprietary REMIC |
| | tranche |
| Sub-Silo Id | Indicator populated when Subsilos are being used. |
| Security | Specify the data type the look-through is for. Valid values are: |
| Record Type | 1 = Security Gross - up |
| | 2 = Mega Collateral Transfer |
| | 3 = Deal Collateral Transfer |
| | 4 = Group Collateral Transfer |
| | 5 = Sub-silo Collateral Transfer |
| | 6 = Deal Gross - up |
| | 7 = Group Gross - up |
| | 8 = Silo Gross - up |
| | 9 = Mega Liability |
| | 10 = Deal Liability |
| | 11 = Group Liability |
| | 12 = Sub - silo Liability |
| REMIC | REMIC Group/Deal Identifier, only if the CUSIP is a REMIC |
| Group/Deal ID | tranche. Otherwise this is null. |
| Deal Name | Structure deal unique identifier |

TABLE C3
ASAP consolidation data

| Business | |
|---|---|
| Data Element | |
| Field | Description |
| CUSIP | Nine digit security identifier |
| TradeNo | Trade number on the transaction that moved the security |
| | from ELF to Portfolio. |
| Wire Date | The wire data on the trades. |
| Consolidation | The first consolidation date on the ASAP. |
| Date | |

TABLE C4
RCR Grantor Trust

| Business | |
|---|---|
| Data Element | |
| Field | Description |
| CUSIP | Nine digit security identifier |
| Accounting | Current accounting period - Accounting Month and Year |
| Period | |
| Accounting | Indicates the FIN 46 consolidation status of the CUSIP. Values as |
| Status Flag | shown below: |
| | “S” - Secured borrowing |
| | “C” - Consolidate at Fair Value |
| | “L” - First time % Ownership <= 90% |
| | “D” - Derecognize |
| | “R” - Continuous Consolidation |
| | “N” - Never Consolidated or continuous derecognition |
| | “P” - Continuous Secured Borrowing |
| | “F” - Consolidate at Book Value |
| | “T” - Transition for Pre 1997 originated PPS CUSIPs @ AOD |
| | Dec. 31, 2003 |
| | “M” - Transition at Dec. 31, 2003 for Qfail/PB CUSIPs |
| Transaction | Date of the accounting status flag application-effective day of FIN 46 |
| Date/Effective | event |
| Date | |
| UPB Owned | Amount of UPB that the reporting entity owns. This UPB includes |
| | daily position, transfers, and all gross-ups. |
| Daily Position | Amount of UPB owned in the portfolio before any transfers. |
| UPB | |
| Par | Par of the CUSIP transferred. Does not include the minority interest |
| | or secured borrowing gross up amount. The parent would have |
| | negative Par and the children would have positive Par. This is calculated |
| | as follows: UPB (above)/Current Month Factor |
| FV Price | Fair Value Price of the Security only if it is a proprietary REMIC |
| | tranche |

TABLE C5
Other FDW Provided Data Elements

| Business | |
|---|---|
| Data Element | |
| Field | Description |
| SF/MF | Indicates security Single Family or Multifamily status |
| Indicator | |
| Proprietary | Indicates the type of underlying collateral |
| Flag | Valid Values: Yes or No. |
| | These values are not part of any lookup table in MAST |
| | or IRIS. This data is loaded into CCI directly from |
| | spreadsheets provided to them. This field must come |
| | from CCI directly. |
| Security Type | Indicate structure product type. |
| | Valid Values: REMIC, STRIP, Grantor Trust, MEGA, |
| | DMBS |
| Class Collateral | Indicates that the REMIC is backed by whole loan loans |
| Issuer | or whether it is a wrap on a Private Label REMIC. |
| Issuer | Identifies issuer of security |
| Par Issued | The original issued amount on the security. |
| Qfail/PB | Indicates the date the security failed Q or became a |
| Effective Date | primary beneficiary |
| Qfail Flag | Indicates that the product is a Q-fail |
| PB Flag | Indicates the security was the Primary Beneficiary of a |
| | Q-Fail |
| Residual Flag | Indicates whether the product was ever in a REMIC (or is |
| | a REMIC) and the residual was owned |

The embodiments of the present invention have been described with reference to drawings. The drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing computers in the form of computers, including a processing unit, a system memory or database, and a system bus that couples various system components including the system memory to the processing unit. The database or system memory may include read only memory (ROM) and random access memory (RAM). The database may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. User interfaces, as described herein may include a computer with monitor, keyboard, a keypad, a mouse, joystick or other input devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention.

Throughout the specification, numerous advantages of the exemplary embodiments have been identified. It will be understood of course that it is possible to employ the teachings herein without necessarily achieving the same advantages. Additionally, although many features have been described in the context of a particular data processing unit, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The invention is not limited to a particular embodiment, but extends to various modifications, combinations, and permutations that nevertheless fall within the scope and spirit of the appended claims.

We claim:

1. A computer-implemented data processing system comprising:
a consolidation engine configured to perform consolidation testing to assess whether investment entities should be consolidated onto a balance sheet of a reporting entity in accordance with predetermined accounting standards, the investment entities being associated with fungible investment instruments, the consolidation engine being configured to generate consolidation indicators that reflect results of the assessment, the consolidation engine being configured to receive accounting treatment indicators and to generate the consolidation indicators based on the accounting treatment indicators, the accounting treatment indicators being at least partially manually generated and reflecting qualitative accounting assessments;
an accounting engine configured to consolidate or deconsolidate the investment entities from the balance sheet of the reporting entity based on the consolidation indicators.

2. A system according to claim 1, wherein the consolidation engine is configured to receive daily position information concerning the investment entities.

3. A system according to claim 2, wherein the daily position information is updated on a daily basis to permit the consolidation indicators to be generated on a daily basis.

4. A system according to claim 1, wherein the accounting treatment indicators are received on less than a daily basis.

5. A system according to claim 1, wherein the predetermined accounting standards comprise FASB Interpretation Number 46.

6. A system according to claim 1 wherein, to generate the consolidation indicators, the consolidation engine is configured to apply a qualified special purpose entity test and a primary beneficiary test to the investment entities.

7. A system according to claim 1 wherein, to generate the consolidation indicators, the consolidation engine is configured to calculate a percentage ownership for each of the investment entities.

8. A system according to claim 1, further comprising a look-through engine coupled to the consolidation engine, the look-through engine being configured to replace tranches of an investment instrument by underlying collateral that backs each tranche and transfer the owned unpaid principal balance of the tranches to the underlying collateral, the look-through engine being configured to cooperate with the consolidation engine to perform additional ownership tests on each of the underlying collateral to determine if additional consolidation is to be performed on the underlying collateral.

9. A computer-implemented data processing system comprising:
a consolidation engine configured to perform consolidation testing to assess whether investment entities should be incorporated onto a balance sheet of a reporting entity in accordance with predetermined accounting standards, the investment entities being associated with fungible investment instruments, the consolidation engine being configured to generate consolidation indicators that reflect results of the assessment, the consolidation engine being configured to receive daily position information concerning the investment entities from a database, the consolidation engine being configured to receive accounting treatment indicators and to generate the consolidation indicators based on the accounting treatment indicators, the accounting treatment indicators being at least partially manually generated and reflecting qualitative accounting assessments, the daily position information being received on a daily basis to permit the consolidation indicators to be generated on a daily basis, the accounting treatment indicators being received on less than a daily basis;
a look-through engine coupled to the consolidation engine, the look-through engine being configured to replace tranches of an investment instrument by underlying collateral that backs each tranche and transfer the owned unpaid principal balance of the tranches to the underlying collateral, the look-through engine being configured to cooperate with the consolidation engine to perform additional ownership tests on each of the underlying collateral to determine if additional consolidation is to be performed on the underlying collateral;
an accounting engine configured to receive the consolidation indicators and to consolidate or deconsolidate the investment entities from the balance sheet of the reporting entity based on the consolidation indicators.

10. A system according to claim 9, wherein the predetermined accounting standards comprise FASB Interpretation Number 46.

11. A system according to claim 9 wherein, to generate the consolidation indicators, the consolidation engine is configured to apply a qualified special purpose entity test and a primary beneficiary test to the investment entities.

12. A system according to claim 9 wherein, to generate the consolidation indicators, the consolidation engine is configured to calculate a percentage ownership for each of the investment entities.

13. A computer-implemented data processing system comprising:
a consolidation engine configured to perform consolidation testing to assess whether investment entities should be consolidated onto a balance sheet of a reporting entity in accordance with predetermined accounting standards, the investment entities being associated with fungible investment instruments, the consolidation engine being configured to generate consolidation indicators that reflect results of the assessment;
a look-through engine coupled to the consolidation engine, the look-through engine being configured to replace tranches of an investment instrument by underlying collateral that backs each tranche and transfer the owned unpaid principal balance of the tranches to the underlying collateral, the look-through engine being configured to cooperate with the consolidation engine to perform additional ownership tests on each of the underlying collateral to determine if additional consolidation is to be performed on the underlying collateral;
an accounting engine configured to receive the consolidation indicators and to consolidate or deconsolidate the investment entities from the balance sheet of the reporting entity based on the consolidation indicators.

14. A system according to claim 13, wherein the consolidation engine is configured to receive daily position information concerning the investment entities.

15. A system according to claim 14, wherein the daily position information is updated on a daily basis to permit the consolidation indicators to be generated on a daily basis.

16. A system according to claim 13, wherein the consolidation engine is configured to receive accounting treatment indicators, the accounting treatment indicators being at least partially manually generated and reflecting qualitative accounting assessments.

17. A system according to claim 16, wherein the accounting treatment indicators are received on less than a daily basis.

18. A system according to claim 13, wherein the predetermined accounting standards comprise FASB Interpretation Number 46.

19. A system according to claim 13 wherein, to generate the consolidation indicators, the consolidation engine is configured to apply a qualified special purpose entity test and a primary beneficiary test to the investment entities.

20. A system according to claim 13 wherein, to generate the consolidation indicators, the consolidation engine is configured to calculate a percentage ownership for each of the investment entities.

21. A computer-implemented data processing system comprising:
a consolidation engine configured to perform consolidation testing to assess whether investment entities should be consolidated onto a balance sheet of a reporting entity in accordance with predetermined accounting standards, the investment entities being associated with fungible investment instruments, the consolidation engine being configured to generate consolidation indicators that reflect results of the assessment, the consolidation engine being configured to receive daily position information concerning the investment entities from a database, the consolidation engine being configured to receive accounting treatment indicators and to generate the consolidation indicators based on the accounting treatment indicators, the accounting treatment indicators being at least partially manually generated and reflecting qualitative accounting assessments, the daily position information being received on a daily basis to permit the consolidation indicators to be generated on a daily basis, the accounting treatment indicators being received on less than a daily basis;
an accounting engine configured to receive the consolidation indicators and to consolidate or deconsolidate the investment entities from the balance sheet of the reporting entity based on the consolidation indicators.

22. A system according to claim 21, wherein the consolidation engine is configured to receive daily position information concerning the investment entities.

23. A system according to claim 21, wherein the predetermined accounting standards comprise FASB Interpretation Number 46.

24. A system according to claim 21 wherein, to generate the consolidation indicators, the consolidation engine is configured to apply a qualified special purpose entity test and a primary beneficiary test to the investment entities.

25. A system according to claim 21 wherein, to generate the consolidation indicators, the consolidation engine is configured to calculate a percentage ownership for each of the investment entities.

26. A system according to claim 21, further comprising a look-through engine coupled to the consolidation engine, the look-through engine being configured to replace tranches of an investment instrument by underlying collateral that backs each tranche and transfer the owned unpaid principal balance of the tranches to the underlying collateral, the look-through engine being configured to cooperate with the consolidation engine to perform additional ownership tests on each of the underlying collateral to determine if additional consolidation is to be performed on the underlying collateral.
